(19) United States
(12) Patent Application Publication
(10) Pub. No.: US 2026/0329725 A1
(43) Pub. Date: Oct. 22, 2026

(54) DEBUGGING DEVICE AND DEBUGGING METHOD

(71) Applicant: Mitsubishi Electric Corporation, Tokyo (JP)

(72) Inventor: Katsumi OKUDA, Tokyo (JP)

(73) Assignee: Mitsubishi Electric Corporation, Tokyo (JP)

(21) Appl. No.: 19/112,267

(22) PCT Filed: Sep. 27, 2022
(86) PCT No.: PCT/JP2022/035836

§ 371 Date: Mar. 17, 2025

(51) Int. Cl. G06F 11/362

(52) U.S. Cl. CPC G06F 11/3628

(57) ABSTRACT

A debugging device includes a program execution means to execute a program including optimized code and unoptimized code corresponding to the same source code as well as a line number table for the optimized code and a line number table for the unoptimized code; a breakpoint setting means to set, when a breakpoint is designated at a location of the source code, breakpoints at an instruction level at two locations, one in the optimized code and the other in the unoptimized code; and a breakpoint switching means to switch code to be executed from the optimized code to the unoptimized code when the program stops at the breakpoint in the optimized code set by the breakpoint setting means.

### TECHNICAL FIELD

The present invention relates to debugging of a program executed by a computer.

Debugging is an essential part of development of a computer program. It is difficult for even a skilled programmer to create a program that works as expected from the beginning. Normally, once a program is written, it is executed and tested, and the program is rewritten as the test results are reviewed. When a program does not work as expected, the programmer debugs the program to find an error. A debugger provides the functionality to stop the execution of a running program or to perform step-by-step execution. The debugger allows the programmer to freely read and write data while the program is stopped. At this point, the user does not have to rewrite the program for debugging and can therefore work on the debugging more efficiently.

There are two types of step-by-step executions: execution of each instruction in a machine language program and execution of each statement in a high-level language. When debugging a program of a high-level language, step-by-step execution of each statement is essential. Patent Document 1 describes a method for step-by-step execution of each statement. The invention of Patent Document 1 relates to a step-by-step execution method of high-level languages. In the step-by-step execution method of a high-level language, the computer is caused to perform step-by-step execution based on a source program written in the high-level language. Each line of the source program serves as a unit of step-by-step execution. By sequentially executing the machine code corresponding to each line, the statements in the high-level language are each executed step by step.

### PRIOR ART DOCUMENTS

### Patent Documents

[Patent Document 1] Japanese Unexamined Patent Application Publication No. S61-180342

### SUMMARY OF THE INVENTION

### Problems to be Solved by the Invention

Thus, a conventional step-by-step execution means has achieved step-by-step execution by executing a series of consecutive sequences of machine language instructions which corresponds to one line of the source program. However, when the source program is optimized, the lines of the source program are compiled into multiple instruction sequences in an arbitrary order, preventing step-by-step execution in the correct order. Therefore, in order to support step-by-step execution, it is necessary to use a program without optimization, which makes execution speed slow. The purpose of the present invention is to solve this problem by providing the users with the same debugging capabilities as the programs without optimization, while mainly running the programs with optimization.

A debugging device according to the present invention includes: a program execution means to execute a program including optimized code and unoptimized code corresponding to the same source code as well as a line number table for the optimized code and a line number table for the unoptimized code; a breakpoint setting means to set, when a breakpoint is designated at a location of the source code, breakpoints at an instruction level at two locations, one in the optimized code and the other in the unoptimized code; and a breakpoint switching means to switch code to be executed from the optimized code to the unoptimized code when the program stops at the breakpoint in the optimized code set by the breakpoint setting means.

A debugging method according to the present invention includes steps of: executing a program including optimized code and unoptimized code corresponding to the same source code as well as a line number table for the optimized code and a line number table for the unoptimized code; setting, when a breakpoint is designated at a location of the source code, breakpoints at an instruction level at two locations, one in the optimized code and the other in the unoptimized code; and switching code to be executed from the optimized code to the unoptimized code when the program stops at the breakpoint set in the optimized code by the breakpoint setting means.

### Effects of the Invention

The present invention makes it possible to execute a program faster using optimized code until a breakpoint at the source code level is set and to provide capabilities for interactive debugging operations such as step-by-step execution using unoptimized code after the breakpoint is set.

### BRIEF DESCRIPTION OF DRAWINGS

FIG. 1 is a block diagram showing an example of a debugging device according to Embodiment 1.

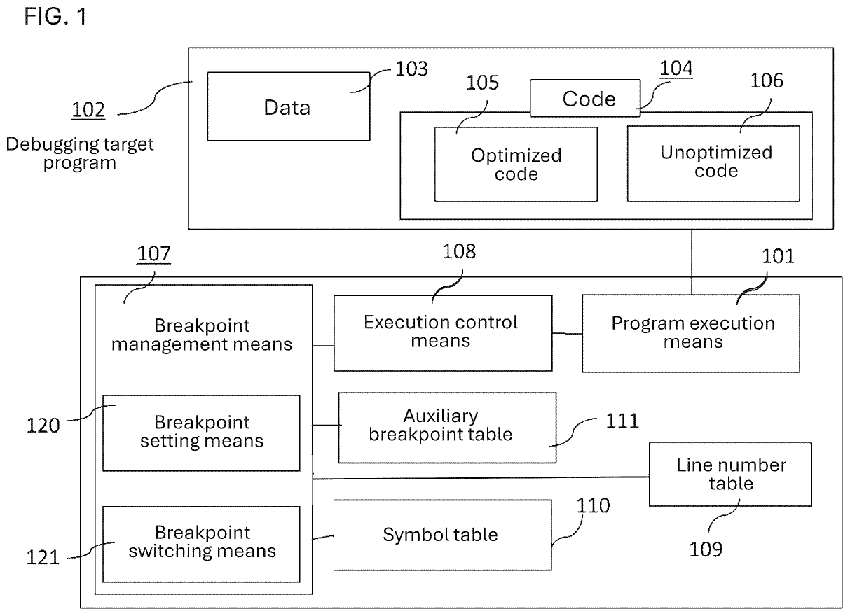

FIG. 2 is a diagram showing an example of a program that is assumed to be a debugging target.

FIG. 3 is a diagram showing an example of a disassembly result of optimized code.

FIG. 4 is a diagram showing an example of a line number table for the optimized code.

FIG. 5 is a diagram showing an example of a disassembly result of unoptimized code.

FIG. 6 is a diagram showing an example of a line number table for the unoptimized code.

FIG. 7 is an example of a flowchart of a breakpoint management means.

FIG. 8 is an example of a flowchart of a breakpoint setting process.

FIG. 9 is an example of a flowchart of a breakpoint clearing process.

FIG. 10 is an example of a flowchart of the breakpoint management means.

### EMBODIMENTS FOR CARRYING OUT THE INVENTION

### Embodiment 1

In the present invention, a program execution means 101 executes a debugging target program 102. The program execution means 101 is a central processing unit (CPU), but instead of a real CPU, it can be a CPU emulator, a virtual machine, an interpreter, or an instruction set simulator, etc. The debugging target program 102 is a program obtained by compiling a program of a high-level language. The debugging target program 102 includes various data 103 and code 104, etc., and is stored in a storage device such as a memory.

The code 104 includes optimized code 105 and unoptimized code 106. The optimized code 105 and the unoptimized code 106 are part of the machine language code 104 generated from the same source program. For each function of the original source program, there are these two types of code: the code 105 with optimization and the code 106 without optimization. The code 104 that the program execution means 101 normally executes is the optimized code 105. On the other hand, when interactive operation is to be provided to a user, the program execution means 101 executes the unoptimized code 106. That is, the program execution means 101 is to execute the debugging target program 102 including the optimized code 105 and the unoptimized code 106 both corresponding to the same source code as well as a line number table 109 for the optimized code 105 and a line number table 109 for the unoptimized code 106.

A breakpoint management means 107 includes a breakpoint setting means 120 and a breakpoint switching means 121. The breakpoint setting means 120 accepts a breakpoint specified by a source file name and a line number in the high-level language and sets the breakpoint to both the optimized code 105 and the unoptimized code 106 by using the line number table 109 and a symbol table 110. That is, when a breakpoint is set at a location in the source code, the breakpoint setting means 120 sets breakpoints at two locations at an instruction level, one for the optimized code 105 and the other for the unoptimized code 106. The locations at which the breakpoints are set will be described in more detail later.

An execution control means 108 switches the code to be executed by the program execution means 101 from the optimized code 105 to the unoptimized code 106 based on the set breakpoints. In addition, the line number table 109 maintains correspondence information between the line numbers of the source program and instruction addresses of the unoptimized code 106.

The symbol table 110 maintains an address and a size of a region corresponding to each symbol such as a variable name or a function name in the source code. Here, the symbol table 110 maintains both an address in the optimized code 105 and an address in the unoptimized code 106 for one function name in the source code. The symbol table 110 also includes start addresses and sizes of the functions. Thus, a function can be identified by searching the symbol table 110 for an address of an instruction that constitutes part of the function. For example, if an entry in the symbol table 110 includes a start address of f and a size of's for a function, it is possible to check whether the instruction at a given address a is part of the function by determining whether the address a is greater than or equal to f and less than f+s. It is possible to obtain a start address, a symbol name, etc. of a function from the address that is part of the function by repeating this procedure for all the entries in the symbol table 110.

In the following, a case of debugging a simple program is used as an example. First, a scenario for step-by-step execution that can be realized according to the present embodiment is shown. Then, the details of the problems with conventional debugging methods as well as the unique features of the present invention, that is, the breakpoint management means 107 and the execution control means 108, capable of solving these problems, are shown.

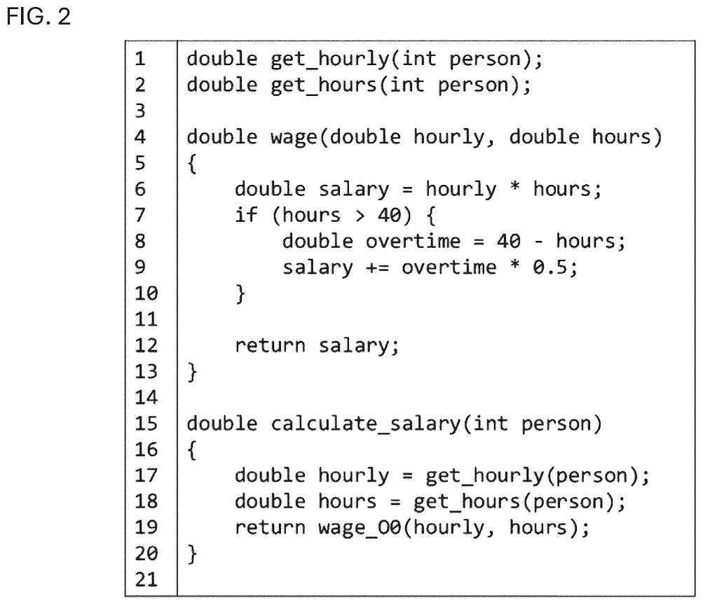

FIG. 2 shows an example of a program that is assumed to be a debugging target. As an example, here, a case of debugging part of a payroll program will be considered. It is assumed that the programmer wants to check whether the overtime pay has been calculated correctly by performing step-by-step execution for lines 8 and 9 of the program shown in FIG. 2. In this case, the programmer can check whether the salary, including overtime, is calculated as the programmer intended by performing step-by-step execution for lines 8 and 9 and obtaining the values of the overtime and salary variables.

If such step-by-step execution is desired, the programmer sets a breakpoint at line 8 and then starts to execute the program. A short time later, when the program is stopped at the breakpoint on line 8, the debugger provides the programmer with an interactive operation, such as step-by-step execution of the program. If the programmer directs the debugger to perform step-by-step execution for line 8, the program stops at line 9. Then, if step-by-step execution is directed again, it stops at line 10.

If the above debugging is to be performed by a conventional debugging method, it is necessary to use the unoptimized code 106. In other words, if the optimized code 105 of a function wage in FIG. 2 is the debugging target, it is not possible to debug it as described above. This problem will be described below using the optimized code 105 of the function wage and the corresponding line number table 109.

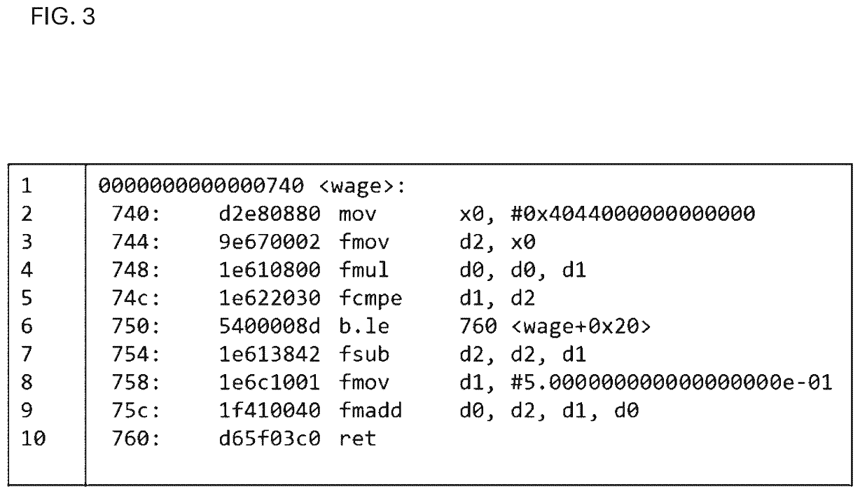

First, FIG. 3 is a diagram showing a disassembly result of the optimized code 105 generated from the source program of FIG. 2. The format of FIG. 3 conforms to the format of the disassembly result obtained with the objdump command for GNU binutils. Line 1 indicates that the function wage begins at address 0x740. Lines 2 through 10 are the disassembly result of the instruction sequences included in the function wage. For example, Line 2 shows that the instruction code at address 740 is 0xd2e80880, which means that the mnemonic is mov. The mov instruction also means that the immediate value of 0x4044000000000000 is stored in register x0. The details of each instruction are not directly related to the present invention and are therefore omitted from the description.

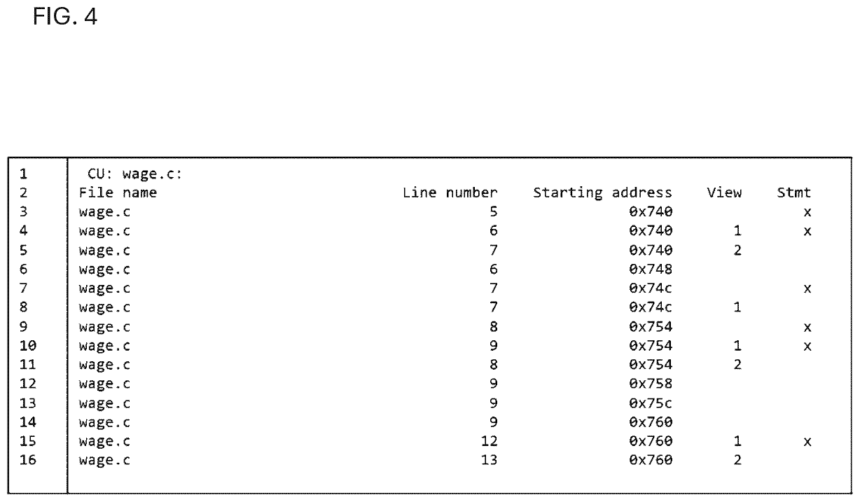

Next, FIG. 4 is a diagram showing the line number table 109 for the optimized code 105 corresponding to the function wage of FIG. 2. The format of the line number table 109 in FIG. 4 conforms to the output format of the dump result of the line number information obtained with the readelf command for GNU binutils. Rows 3 through 16 show the correspondence between each line of the actual source code and its address. Column 1 shows the file name, Column 2 shows the line number, and Column 3 shows the corresponding address. For example, row 3 shows that line 5 of the file name wage.c is located at address 0x740 in the optimized code 105. From FIG. 4, it can be seen that the debugger cannot perform step-by-step execution at the source code level using the optimized code 105. For example, rows 3 through 5 in FIG. 4 show that address 0x740 corresponds to lines 5, 6 and 7 of the source code.

Therefore, it can be seen that even when the instruction at 0x740 is executed with the intention of executing only lines 5 and 6, the processing corresponding to lines 5, 6 and 7 will also be partially executed. Thus, the problem with conventional debugging methods is that it is not possible to perform step-by-step execution for each line of the source code when the optimized code 105 is used.

The basic idea of the present invention is to switch the code to be executed to the unoptimized code 106 and execute it only when debugging provides the user with the interactive operation. Because the breakpoint switching means 121 makes this switching automatically, the user can perform general debugging operations, such as step-by-step execution and variable display, as if executing the unoptimized code 106 from the beginning.

The interactive operation with the user starts when the program stops at a breakpoint.

The following will first show a specific example of the unoptimized code 106 and its line number table 109, and then describe how to switch to the unoptimized code 106. Note that the line number table 109 includes an address correspondence table for the unoptimized code 106 and an address correspondence table for the optimized code 105.

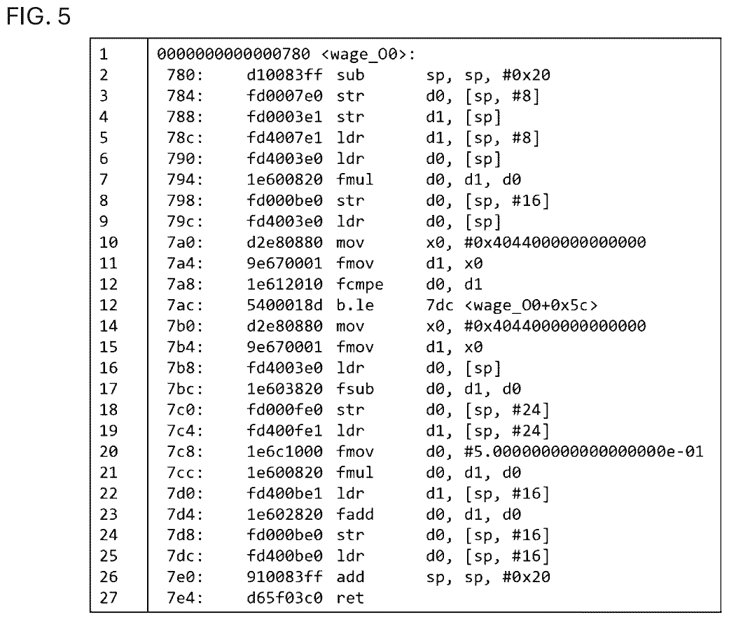

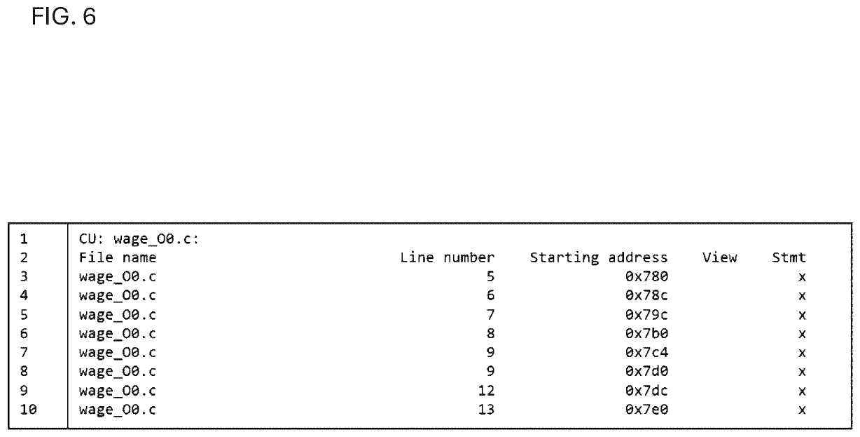

First, the disassembly result of the unoptimized code 106 corresponding to the function wage in FIG. 3 is shown in FIG. 5. The line number table 109 for the unoptimized code 106 is also shown in FIG. 6. Note that in FIG. 6, a suffix “_O2” is added to the end of the base name “wage” of the original file name “wage.c”, as in “wage_O0.c”, to indicate that it is for the unoptimized code 106 generated from “wage.c”. Lines 2 through 27 in FIG. 5 are for the code, which corresponds to the processing of the function wage and begins at address 0x780. In addition, rows 3 through 10 in FIG. 6 show which addresses in the unoptimized code 106 of FIG. 5 lines 5 through 13 of the program of FIG. 2 correspond to. Unlike the case of the optimized code 105, each address always corresponds to only one line, which means that the order of line numbers in the source code and the order of addresses in the unoptimized code 106 are the same.

In other words, with respect to the line numbers in the unoptimized code 106 of FIG. 6, all of the line numbers are different from each other and the instruction sequence is aligned in ascending order. In contrast, with respect to the line numbers in the optimized code 105 of FIG. 4, some of the numbers are the same, and some of the larger numbers precede the smaller numbers, which means that the lines of the source program are compiled into multiple instruction sequences in an arbitrary order, preventing step-by-step execution in the correct order. Thus, it is easy to trace the unoptimized code 106 back to the line numbers of the source code, whereas it is not easy to trace the optimized code 105 back to the line numbers of the source code. Obviously, the execution speed is faster for the optimized code 105 than for the unoptimized code 106.

The following shows a breakpoint setting procedure in the case where the user has designated to set a breakpoint at the source code level in the nth line of the source code of the file name s. Here, a solution approach is described using the example of the present embodiment. In the remainder of this specification, for the sake of differentiation, a breakpoint designated by a pair of a file name and a line number will be referred to as a source level breakpoint, and a breakpoint designated by a memory address of an instruction at which the program control means 108 actually stops the program will be referred to as an instruction level breakpoint.

The breakpoint setting means 120 sets an instruction level breakpoint to the instruction address in the unoptimized code 106 corresponding to the source file name s and the line number n designated by the user.

However, the program execution means 101 is normally configured to execute the optimized code 105 and not to execute the unoptimized code 106. Therefore, the breakpoint management means 107 also sets an auxiliary instruction level breakpoint in the optimized code 105 so that the execution control means 108 can switch the code 104 to be executed from the optimized code 105 to the unoptimized code 106. The execution control means 108 switches the code to be executed from the optimized code 105 to the unoptimized code 106 when the program is stopped at the auxiliary breakpoint.

In other words, when the program is stopped at a breakpoint in the optimized code 105 set by the breakpoint setting means 120, the breakpoint switching means 121 switches the code to be executed from the optimized code 105 to the unoptimized code 106.

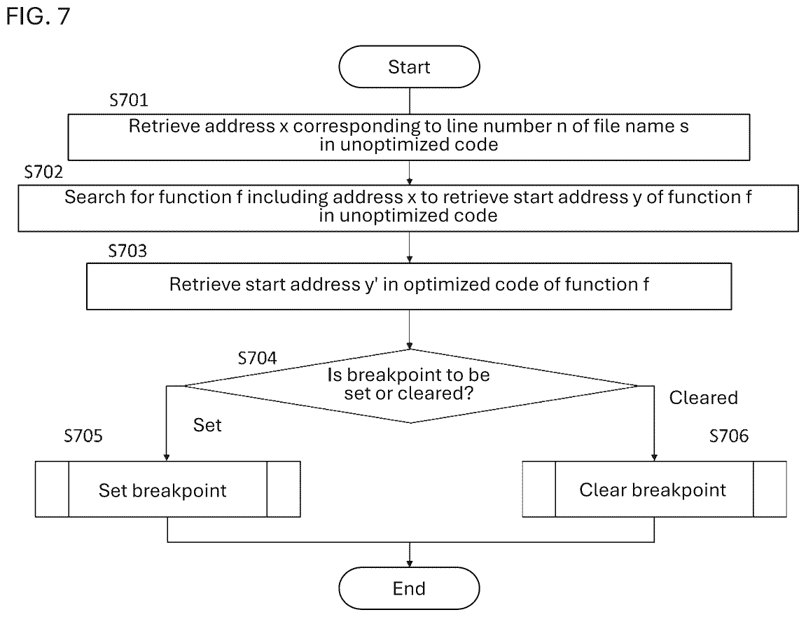

FIG. 7 is a flowchart of the breakpoint management means 107. The inputs are a file name s, a line number n, and a type of breakpoint operation designated by the user. There are two types of the breakpoint operations that can be designated: set or clear.

First, in step S701, the address x corresponding to the file name s and the line number n is retrieved from the line number table 109 for the unoptimized code 106. For example, if line 8 of the program wage.c in FIG. 2 is designated, s is wage.c and n is 8. At this time, row 6 in FIG. 6 shows that line 8 of wage.c begins at address 0x7b0. Thus, in this case, x is 0x7b0. Note that in FIG. 6, wage.c is renamed to wage_O0.c to indicate that it is the unoptimized code 106.

Next, in step S702, the symbol table 110 is searched for the function f including the instruction address x, and the start address y of the function f in the unoptimized code 106 is retrieved. For example, if the function f is wage, the start address y begins at address 0x780, as shown in line 2 in FIG. 5. The wage and 0x780 are obtained by searching the symbol table 110 using the instruction address x, which is 0x7b0.

Next, in step S703, the start address y′ in the optimized code 105 of the function f is obtained from the symbol table 110. When searching the symbol table 110 in step S702, the symbol name of the function f is obtained, and the obtained symbol name can be used in the search of the symbol table 110 in step S703. Note that, as described earlier, the symbol table 110 maintains the addresses of each function for both the optimized code 105 and the unoptimized code 106. For example, when the function f is wage, the start address y′ of the optimized function wage is 0x740 from line 2 in FIG. 3. This 0x740 is obtained by searching the symbol table 110 for the start address of the function wage that is optimized.

When a breakpoint is designated, the breakpoint setting means 120 sets an auxiliary breakpoint at the beginning of a subroutine that includes the location of the designated breakpoint as part. This allows the program to be executed fast by executing the optimized code 105 up to a location as close as possible to the source code level breakpoint. Here, note that the beginning of a subroutine is a location that allows for the switching from the optimized code 105 to the unoptimized code 106 and is relatively close to the user-designated source code level breakpoint which is included in the subroutine.

In other words, when a breakpoint is designated, the breakpoint setting means 120 sets an auxiliary breakpoint at the beginning of a subroutine that is located higher in a call graph than the subroutine that includes the location of the breakpoint as part.

In step S704, if the user operation sets a breakpoint, the process proceeds to step S705, and if the user operation clears (deletes) a breakpoint, the process proceeds to step S706. Step S705 and step S706 are both processes whose inputs are the address x in the unoptimized code 106, the start address y in the function f in the unoptimized code 106, and the address y′ in the function f in the optimized code 105. A breakpoint is set in step S705, and a breakpoint is cleared (deleted) in step S706.

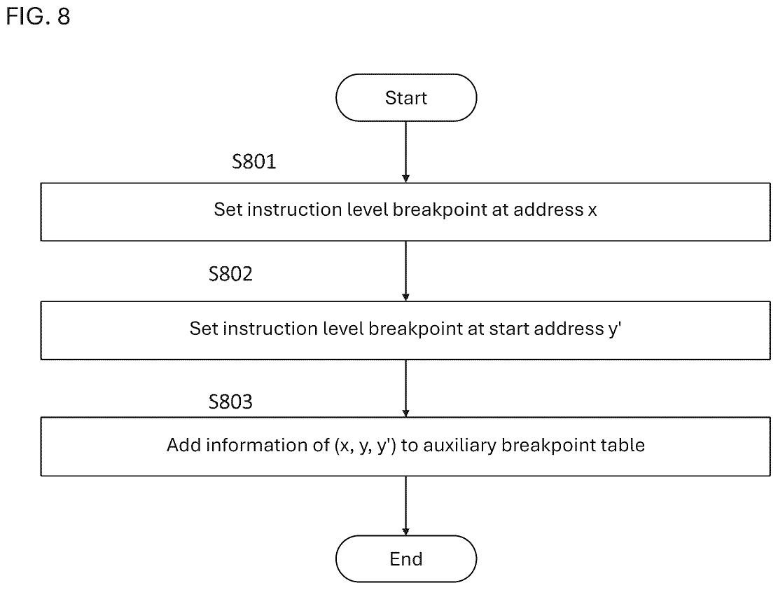

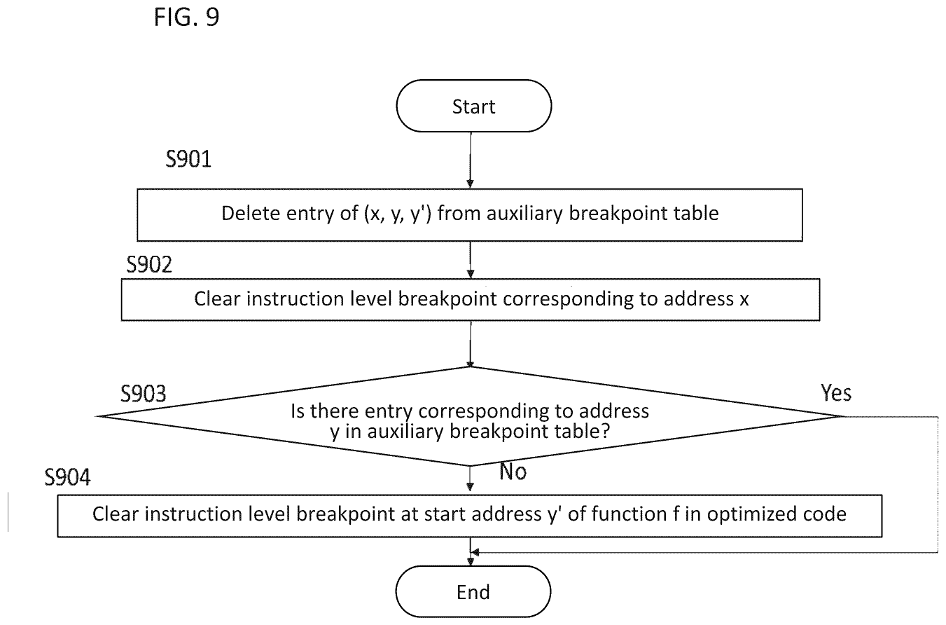

In the following, a breakpoint setting procedure and a breakpoint clearing procedure will be described using the flowcharts of FIG. 8 and FIG. 9, respectively.

FIG. 8 is a flowchart of the breakpoint setting process. The input is a 3-tuple of addresses (x, y, y′). Here, x is an address in the unoptimized code 106, y is the start address of the function f in the unoptimized code 106, y′ is the start address of the function f in the optimized code 105, and the function f is a function that includes the instruction of the address x as part. For example, the 3-tuple corresponding to line 8 of the program wage.c in FIG. 2, which has been used as an example, is (0x7b0, 0x780, 0x740).

In step S801, an instruction level breakpoint is set at the address x. The method of setting an instruction level breakpoint remains the same as conventional, and a hardware breakpoint or a software breakpoint can be used. For example, if x is 0x7b0, a breakpoint is set to the instruction corresponding to line 14 in FIG. 5.

Next, in step S802, an instruction level breakpoint is set to the start address y′. For example, if y′ is 0x740, a breakpoint is set to the instruction corresponding to line 2 in FIG. 3.

Finally, in step S803, information of (x, y, y′) is added to an auxiliary breakpoint table. The 3-tuple (x, y, y′) is stored in the auxiliary breakpoint table 111.

FIG. 9 shows a flowchart of a breakpoint clearing process. The inputs are the same as those for the breakpoint setting process. In step S901, the 3-tuple (x, y, y′) is deleted from the auxiliary breakpoint table 111. Next, in step S902, the instruction level breakpoint at the address x in the unoptimized code 106 is cleared.

Next, in step S903, whether there is an entry corresponding to the address y in the auxiliary breakpoint table 111 is checked. If there is an entry corresponding to the addresses y and y′ of the function f in the auxiliary breakpoint table 111, the process skips step S904 and ends. If there is no such entry, the process proceeds to step S904. In step S904, the instruction level breakpoint at the start address y of the function f in the optimized code 105 is cleared, and the process ends. The method of clearing the instruction level breakpoint remains the same as conventional whether it is implemented as a hardware breakpoint or as a software breakpoint.

When deleting an auxiliary breakpoint, the breakpoint setting means 120 checks whether the auxiliary the breakpoint is shared. In step S903, whether there is an entry corresponding to the address y in the auxiliary breakpoint table 111 is checked. This allows a single auxiliary breakpoint, y, to be shared by multiple source level breakpoints.

For example, if source level breakpoints are set at two locations, line 8 and line 9, in the source code wage.c of FIG. 8, both of these auxiliary breakpoints fall at the start address of the function wage in the optimized code 105. In such a case, if there is no confirmation process of step S903, clearing the breakpoint set at line 8 of wage.c also clears the auxiliary breakpoint set for the source level breakpoint set at line 9. As a result, the source level breakpoint at line 9 is also invalidated. However, with the confirmation process implemented in step S903, the clearing of the auxiliary breakpoint can be skipped, so that the source level breakpoint at line 9 remains valid even after the source level breakpoint at line 8 is cleared.

When the program is stopped at the start address y of the function f, the execution control means 108 can switch the code from the beginning y of the optimized code 105 of the function f to the unoptimized code 106y′. Immediately after a function call, as for the state of CPU staking, the top of the stack is loaded with arguments and return addresses, and the stack for local variables and register saving is not yet used. This allows the optimized code 105 to continue the execution by taking over the stack frame initialized by the optimized code 105.

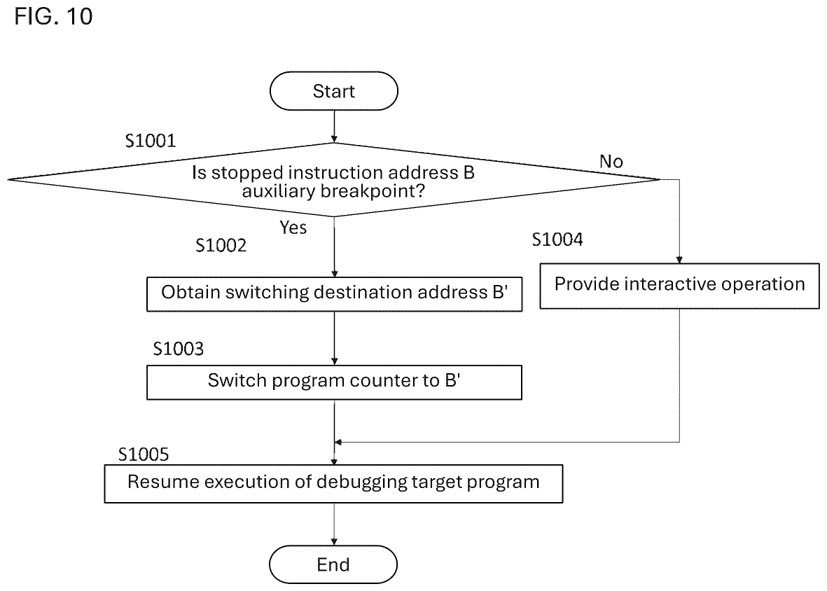

Next, the operation of the breakpoint management means 107 and, especially, the operation of the breakpoint switching means 121 will be described using the flowchart in FIG. 10.

The breakpoint switching means 121 is performed when the program is stopped at an instruction breakpoint. Assuming that the input in the process of the flowchart in FIG. 10 is an instruction address B at which the program is stopped, when the program is stopped, for example, at an instruction level breakpoint at line 2 in FIG. 3, B is 0x740.

In step S1001, whether the stopped instruction address B is an auxiliary breakpoint or not is checked. This confirmation can be done by checking whether or not there is, in the auxiliary breakpoint table 111, an entry in which the third element y′ of the 3-tuple is the instruction address B. Note that the 3-tuple of the entry in the auxiliary breakpoint table 111 updated in step S803 of FIG. 8 consists of the address x of the instruction breakpoint in the unoptimized code 106, the start address y of the function in the unoptimized code 106, and the start address y′ of the function in the optimized code 105.

If the stopped instruction address B is an auxiliary breakpoint, step S1002 and S1003 are performed, otherwise step S1004 is performed. For example, when the stopped instruction address B is 0x740, if there is (0x7b0, 0x780, 0x740) in the auxiliary breakpoint table 111, the stopped instruction address B is an auxiliary breakpoint.

In step S1002, a switching destination address B′ is obtained from the auxiliary breakpoint table 111.

Here, an entry that satisfies y′=B is searched for, and in the entry, the start address y of the function in the unoptimized code 106 is used as the switching destination address B′. When the stopped instruction address B is 0x740 and the entry obtained from the auxiliary breakpoint table 111 is (0x7b0, 0x780, 0x740), then the switching destination address B′ is 0x780.

Next, in step S1003, the program execution means 101 switches the current program counter of the debugging target program from the stopped instruction address B to the switching destination address B′, and the process proceeds to step S1005.

On the other hand, in step S1004, which is a case of a program stop at a normal breakpoint, the user is provided with the interactive operation to start interactive processes. For example, if a breakpoint is set at line 8 in the program of FIG. 3, which has been used as an example so far, the program is stopped at 0x7b0, which corresponds to line 14 in FIG. 5, as a normal breakpoint. At this time, the program has already switched to the unoptimized code 106, so that it is possible to provide the user with operations such as step-by-step execution and display of local variables.

Upon completion of step S1004, the process proceeds to step S1005. In step S1005, execution of the debugging target program 102 is resumed. If the stopped instruction address B is an auxiliary breakpoint, the code 104 at this point is already switched from the optimized code 105 to the unoptimized code 106. Then, after running for a while, the program stops at the breakpoint of the unoptimized code 106 to interrupt the process again. Because this sequence of processes is automatic, the user is unaware of the program stop. On the other hand, if the breakpoint is not an auxiliary address, the execution control means 108 enters a state of waiting for an operation from the user. In this state, the debugging target has already switched to the unoptimized code 106, so that it is possible to display the values of the variables and perform step-by-step execution with conventional procedures.

In the present embodiment, the C language is exemplified as a high-level language, but the present invention does not limit the high-level languages to the C language. In the present invention, a high-level language is assumed to be a program description language that can be a source for compilation into a machine language program. The source languages for compilation include not only textual programming languages, but also visual programming languages. Examples of the visual languages include the FBD language of IEC61131-3, block line diagrams as used in MATLAB (registered trademark)/Simulink, etc.

Line numbers in the present embodiment are a kind of address for designating a particular statement in the source code. If the high-level language is a visual programming language, the line numbers correspond to the addresses of visual program elements. For example, if the high-level language is a block line diagram in MATLAB (registered trademark)/Simulink, the identifiers of the blocks are the line numbers. Accordingly, the line number table maintains the correspondence between the addresses of the program elements and the addresses of the instructions. Furthermore, the language of the compilation source may be a machine language. Even if a different language is used as the compilation source, it is compiled into machine language level subroutines for each reusable compilation unit. In the present embodiment, a case where the compilation unit is a function of the C language has been shown.

Another example of the compilation units is subsystems in the case of block line diagrams such as MATLAB (registered trademark)/Simulink. If the source language for compilation is another machine language, the basic blocks or the superblocks can be considered as the compilation units in addition to the subroutines of the machine language program. Also, the languages described as machine languages in the present embodiment do not have to be machine languages with real processors, but can be virtual machines. If the language of the compilation source is a machine language, the addresses of the machine language correspond to the line numbers in the present embodiment.

In addition, in the above description, it is assumed that the same functions exist in the optimized code 105 and the unoptimized code 106. In some cases, however, optimization may cause a function to be expanded inline to another function. For example, if the function f is expanded inline to a function g due to optimization, an auxiliary breakpoint cannot be set at the beginning of the function foo in the optimized code 105. Furthermore, under the false assumption that the auxiliary breakpoint is set, the code 104, where the inline expansion of the code occurred, is executed, so that the program does not stop at the auxiliary breakpoint. To deal with such a case, when a breakpoint is set in the function f, it is sufficient to set an auxiliary breakpoint at the beginning of the function g where the function f is expanded inline.

The present embodiment is described assuming that the unoptimized code 106 is loaded into the main memory in advance, but it may be dynamically loaded when the user sets a breakpoint. Dynamic loading of the unoptimized code 106 as needed saves the amount of space in the main memory until the debugging operation is started.

As described so far, the debugging device includes: a program execution means to execute a program including optimized code and unoptimized code corresponding to the same source code as well as a line number table for the optimized code and a line number table for the unoptimized code; a breakpoint setting means to set, when a breakpoint is designated at a location of the source code, breakpoints at an instruction level at two locations, one in the optimized code and the other in the unoptimized code; and a breakpoint switching means to switch code to be executed from the optimized code to the unoptimized code when the program stops at the breakpoint in the optimized code set by the breakpoint setting means.

Also, the debugging method includes steps of: executing a program including optimized code and unoptimized code corresponding to the same source code as well as a line number table for the optimized code and a line number table for the unoptimized code; setting, when a breakpoint is designated at a location of the source code, breakpoints at an instruction level at two locations, one in the optimized code and the other in the unoptimized code; and switching code to be executed from the optimized code to the unoptimized code when the program stops at the breakpoint set in the optimized code by the breakpoint setting means.

These features allow a program to be executed fast using the optimized code until a source code level breakpoint is set, and once the breakpoint is set, the interactive debugging operations such as step-by-step execution can be provided using the unoptimized code.

### Embodiment 2

Embodiment 1 did not mention a configuration of the function calls for the optimized code 105 and the unoptimized code 106. With respect to a case where a function B is called from a function A, a call to the function B from the function A in the unoptimized code 106 is normally performed within the unoptimized code 106 as a call to the function B. However, there is a problem that when the function A is executed step by step for each line of the source code, if the function B is also executed by the unoptimized code 106, then the execution speed will decrease. Therefore, in the present embodiment, the unoptimized code 106 that makes a call in such a way that every call to any f in the unoptimized code 106 will be a call to the function f in the optimized code 105 is used.

In the present embodiment, by using the unoptimized code 106 configured as such to make a call to the function B in a step-over manner while debugging the function A, the execution speed is faster due to the optimization of the function B.

Meanwhile, the user may want to step in and perform step-by-step execution within the function B. In order to do that, the program is switched from the optimized code 105 to the unoptimized code 106 at the beginning of the function B when entering the step-in operation. One way to achieve such a switchover is to implement the step-in operation using a breakpoint. In this case, the operation of stepping in the function f is realized by a series of processes: setting the breakpoint B at the first line of the function f; executing the program; and clearing the breakpoint B after stopping at the breakpoint B. The function B can be executed step by step as the unoptimized code 106 by applying the same method as shown in Embodiment 1 to set the breakpoint.

### DESCRIPTION OF SYMBOLS

101 . . . program execution means,
102 . . . debugging target program,
103 . . . data,
104 . . . code,
105 . . . optimized code,
106 . . . unoptimized code,
107 . . . breakpoint management means,
108 . . . execution control means,
109 . . . line number table,
110 . . . symbol table,
111 . . . auxiliary breakpoint table,
120 . . . breakpoint setting means,
121 . . . breakpoint switching means

1. A debugging device comprising:
a processor to execute a program; and
a memory to store the program, which when executed by the processor, performs processes of:
executing a debugging target program including optimized code and unoptimized code corresponding to same source code as well as a line number table for the optimized code and a line number table for the unoptimized code;
setting, when a breakpoint is designated at a location of the source code, breakpoints at an instruction level at two locations, one in the optimized code and the other in the unoptimized code; and
switching code to be executed from the optimized code to the unoptimized code when the debugging target program stops at the set breakpoint in the optimized code.

2. The debugging device according to claim 1, wherein, when the breakpoint is designated, an auxiliary breakpoint is set at the beginning of a subroutine that is located higher in a call graph than a subroutine including the location of the breakpoint as part.

3. The debugging device according to claim 1, wherein, when the breakpoint is designated, an auxiliary breakpoint is set at the beginning of a subroutine including the location of the breakpoint as part.

4. The debugging device according to claim 2, wherein, when deleting the auxiliary breakpoint, whether the auxiliary breakpoint is shared is checked.

5. A debugging method comprising:
executing a program including optimized code and unoptimized code corresponding to the same source code as well as a line number table for the optimized code and a line number table for the unoptimized code;
setting, when a breakpoint is designated at a location of the source code, breakpoints at an instruction level at two locations, one in the optimized code and the other in the unoptimized code; and
switching code to be executed from the optimized code to the unoptimized code when the program stops at the breakpoint set in the optimized code.

6. The debugging device according to claim 3, wherein, when deleting the auxiliary breakpoint, whether the auxiliary breakpoint is shared is checked.
